(19) United States
(12) Patent Application Publication
(10) Pub. No.: US 2006/0058053 A1
(43) Pub. Date: Mar. 16, 2006

(54) Method for logging in a mobile terminal at an access point of a local communication network, and access point and terminal for carrying out the method

(76) Inventor: Thomas Jatschka, Kleinengersdorf (AT)

Correspondence Address: Siemens Corporation;Intellectual Property Department, 170 Wood Avenue South, Iselin, NJ, 08830, US

(21) Appl. No.: 10/529,330

(22) PCT Filed: Sep. 24, 2003
(86) PCT No.: PCT/EP03/10637

§ 371 Date: Oct. 7, 2005

(30) Foreign Application Priority Data
Sep. 24, 2002 (DE) 10244462.5

(51) Int. Cl. H04B 7/00

(52) U.S. Cl. 455/522; 455/67.11

(57) ABSTRACT

The invention relates to a method for the initial login of an especially mobile terminal at an access point of a local communication network, whereby a first transmission power of a first radio transmitter/radio receiver of the access point is reduced after detection of the terminal, in such a way that a transmission/reception process can only be carried out in a near field of the access point. The invention also relates to an access point and to a terminal for carrying out the method.

Method for logging in a mobile terminal at an access point of a local communication network, and access point and terminal for carrying out the method

The invention relates to a method for logging in a mobile terminal at an access point of a local communication network according to Claim 1, an access point for carrying out the method according to Claim 8 and a terminal for carrying out the method according to Claim 9.

The merging of information networks and communication networks has resulted in data transmission networks such as local area networks (LANS) increasingly being equipped with wireless access points. These access points allow new network subscribers, also referred to as network nodes, to connect wirelessly to the LAN. This development even allows some networks of this type to exchange data predominantly or completely in a wireless manner.

These kinds of networks also provide scope for unauthorized access to data within the network so that many kinds of approaches have been developed in order to guarantee security.

One approach is to restrict the data exchange within the network to known network nodes, a new network node being made known to the network in that at the initial login, authentication data, generally keys for encrypting data during transmission, is exchanged with the respective access point.

One disadvantage results if this exchange takes place wirelessly. In this case, a possible attacker can intercept the authentication data, to pose as a known terminal for unauthorized access and/or to decrypt the encrypted data by means of the key.

The object underlying the invention is to specify a method and an arrangement which allow unauthorized access to a local communication network with wireless access points to be prevented as far as possible.

This object is achieved by the method based on the preamble of Claim 1 by means of its characterizing features. Furthermore, the object is achieved by the access point based on the preamble of Claim 8 by means of its characterizing features and by the terminal based on Claim 9 by means of its characterizing features.

With the method according to the invention for the initial login of an especially mobile terminal at an access point of a local communication network according to Claim 1, a first transmission power of a first radio transmitter/radio receiver of the access point is reduced after detection of the terminal, in such a way that a transmit/receive process can only be carried out in a near field of the access point.

Opportunities for listening in by means of another terminal device (eavesdropper) not associated with the local communication network are at least considerably reduced by means of the unilateral reduction of the first transmission power of the first radio transmitter/radio receiver of the access point, so that a receive process is only possible in the near field of the access point. Above all an eavesdropper is prevented from evaluating security-related data typically transmitted during the initial login, e.g. authentication keys, since an eavesdropper is not generally in the near field of an access point and both the data from the access point and the data from the terminal logging in for the first time is required for an evaluation. A further advantage is that terminals need not be modified to implement this protection against eavesdropping attacks, for example the protection can even be guaranteed if the terminals are not able to change their transmission power.

With one possible development of the invention a signaling directed at the terminal is implemented advantageously after detection by the access point, which causes the terminal to reduce a second transmission power of a second radio transmitter/radio receiver, the second transmission power being reduced such that a transmit/receive process can only take place in a near field of the terminal, the signaling taking place prior to reducing the first transmission power. In this way neither data transmitted from the access point nor data to be sent by the terminal during the course of the login process can be intercepted by an eavesdropper outside the near field, thereby completely preventing evaluation of the exchanged data.

The signaling preferably takes place by transmitting a first message, which is provided to indicate a received first signal level determined by the access point, in particular a Received Signal Strength Indicator RSSI value, whereby a second signal level, particularly having a higher value, is indicated instead of the first signal level provided. The advantage of this development is the easier implementation thereby rendered possible in already existing systems, which at least partially use transmission via radio, since every radio communication standard essentially reserves the transmission of this type of message as feedback information for the source of the respective signal. This development thus allows terminals to support the method according to the invention without modification. Only the access points have to be configured such that they use this message reserved according to radio communication standards for another purpose, in other words, to signal such a high received signal level irrespective of the level of the signal level actually received, that the terminal (source) reduces its transmission power to such an extent that data can only be received in a near field of the terminal.

If the signaling contains a second message, which prompts the terminal to instruct the user of the terminal to move the terminal into the near field of the access point, unwanted interruption of the data exchange to implement the initial login of the terminal, because the user of the terminal does not know that they have to remain with the terminal in the near field of the access point for the initial login, is prevented.

In a further embodiment, the message is retransmitted after the expiry of a predetermined time interval to ensure that the second message achieves the desired effect, i.e. to make the user aware. To ensure that this message can be received by the terminal, the first transmission power is at least temporarily increased to a level existing at the time of detection.

It is also possible for retransmission to be repeated periodically after expiry of the predetermined time interval in each instance, so that it can be excluded with greater probability that the user has not taken note of the message.

If the first and second radio transmitter/radio receiver function according to a short-range radio standard, the already short transmission distance with this standard is further reduced, so that an eavesdropper is noticed if they attempt to move into the near field covered by the first and second radio transmitter/receiver. In addition, radio transmitters/radio receivers of more recent generations, particularly radio transmitter/radio receivers operating according to the Bluetooth standard, comprise chip sets which allow variation of the transmission power in a terminal.

The inventive access point according to Claim 8 and the inventive terminal according to Claim 9 are distinguished by their means for implementing the method, so that the method according to the invention is supported in the corresponding devices.

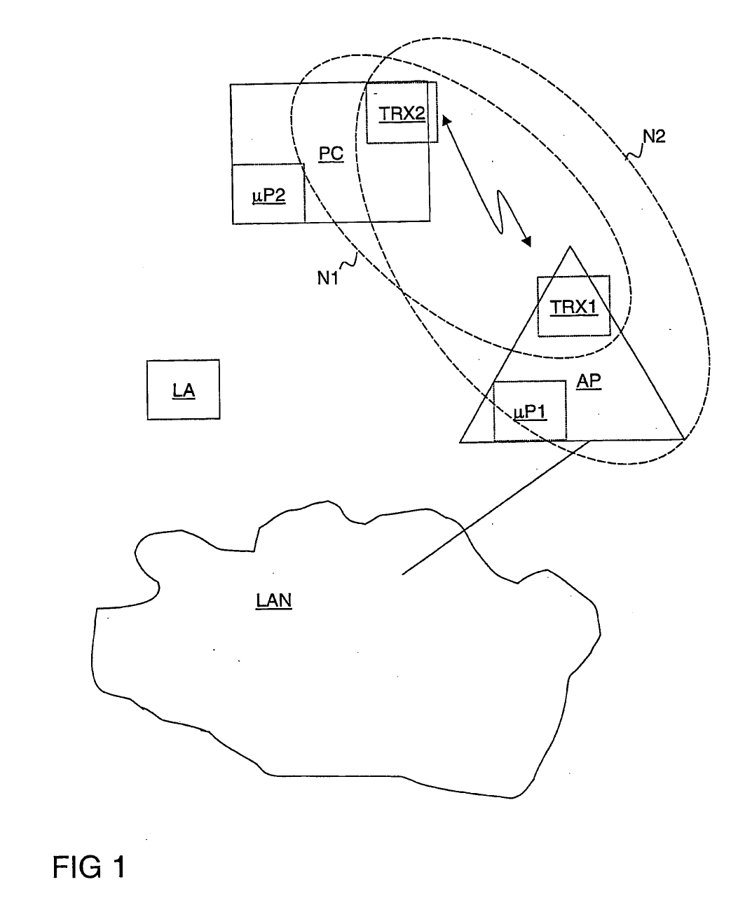

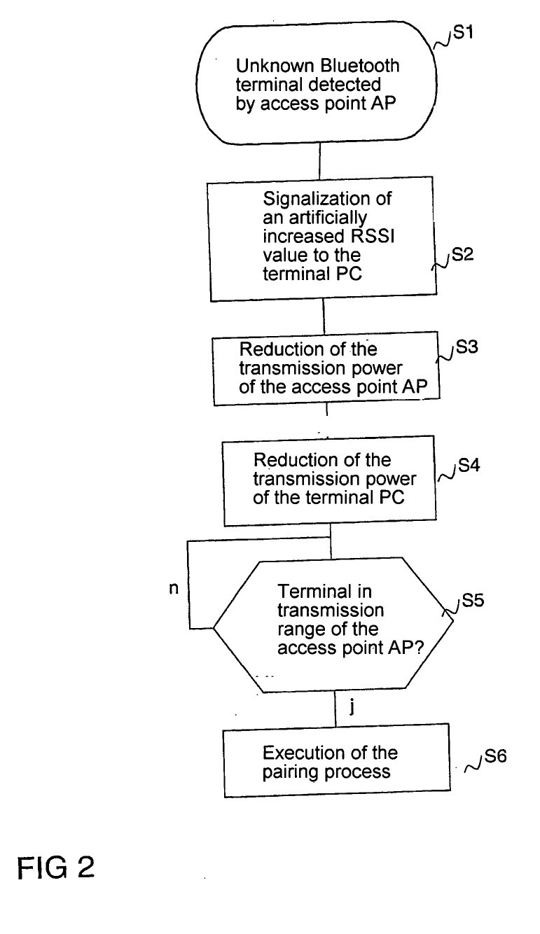

Further details and advantages of the invention are detailed in the FIGS. 1 to 2, in which;

FIG. 1 shows a representation of an arrangement scenario, in which an attempted eavesdropping attack would be possible

FIG. 2 shows a flow diagram of the method according to the invention used in an arrangement according to the scenario.

FIG. 1 shows an arrangement for example, which according to the invention protects against an attempted eavesdropping attack by a terminal LA used for eavesdropping, this being achieved in that a terminal not yet known to a local network LAN, operating according to the Bluetooth standard in the exemplary embodiment shown, is located in a first radio coverage area N1 of an access point AP in the local network LAN.

This first radio coverage area N1 is provided by a first radio transmitter/radio receiver TRX1, a first transmission power of the first radio transmitter/radio receiver TRX1 having a value controlled by a first microprocessor μP1, which limits the range of the first radio coverage area N1 to a near field of the access point AP, in other words having a radius amounting in general to a few decimeters, alternatively even up to a meter.

In addition to the first radio coverage area N1, with this exemplary embodiment the second radio coverage area N2 of a terminal PC to be logged in for the first time is limited to a near field of generally the same range as the range of the first radio coverage area N2. This is achieved by controlling a second transmission power of a second radio transmitter/radio receiver TRX2 of the terminal PC by means of a second microprocessor μP2 (Bluetooth chipset).

The access point AP is located within the second radio coverage area N2 so that data transmission is possible in both directions without any problem, an attempted eavesdropping attack by another unregistered terminal LA being prevented or at least rendered more difficult in that it is not located within the two artificially limited radio coverage areas N1, N2.

An initial login, which is referred to as a pairing process according to the Bluetooth Standard, is particularly critical because during this process a Bluetooth terminal is authenticated on a one-time basis with a network by the transmission of keys and is stored from then on as a known, trusted terminal or trusted device, so that interception of this information (keys) would allow an eavesdropper further unauthorized access to the network.

The arrangement shown in FIG. 1 protects against these types of attack by means of the exemplary embodiment of the method according to the invention, the flow diagram of which is shown in FIG. 2.

The flow diagram shown in FIG. 2 shows the steps to be carried out within the scope of the method according to the invention in the scenario described above.

Generally the method starts with an unknown terminal PC being detected by the access point AP, the access point AP thus having ‘Unknown Bluetooth terminal’ status in a first step S1.

Starting from this first step S1, an artificially increased received signal level is then generally signaled (RSSI value) to the Bluetooth terminal PC in a subsequent second step S2. Artificially increased in this instance means that the actual signal level value determined is generally not signaled, but according to the invention such a high value that the terminal PC reduces its transmission power to a level which results in a second radio coverage area N2 of the terminal PC, which is limited to a near field.

If the method is used a radio system having terminals, which do not support control of the transmission power, the second step S2 can be dispensed with. Alternatively, it is also possible for the second step S2 to be carried out deliberately even if it is a terminal PC which does not support control. In this case eavesdropping protection is only ensured by the access point AP reducing its transmission power in a third step S3 to a value which limits the first radio coverage area N1 to a near field.

In contrast, if the terminal PC supports control of the transmission power, as assumed for this exemplary embodiment, protection against a possible eavesdropper LA is ensured both by reducing the transmission power of the access point AP in the third step S3 and also by reducing the transmission power of the terminal PC in a fourth step S4.

Subsequently it is verified in a fifth step S5 whether the terminal PC is located in the range of the first radio transmitter/radio receiver TRX1 of the access point AP, this being realized for example in that no response is transmitted to the access point on the part of the terminal PC.

This fifth step S5 is repeated in a loop, i.e. requests are sent to the terminal PC, until a response is received, so that it is clear that the terminal is located in the near field of the access point.

To accelerate and/or support this, alternatively and or in addition a message can also be transmitted with the signaling in the second step, which prompts the terminal PC to instruct its user that to move into the near field of the access point AP with the terminal for this pairing process.

Alternatively this request can be made for the first time in conjunction with the fifth step, and/or be periodically repeated after each negative detection result, in order to provide the user with feedback that they are possibly not yet near enough to the access point AP.

If detection in the fifth step S5 indicates that the terminal PC is located in the near field of the access point AP, as shown in FIG. 1, the actual pairing process can be started in the sixth step S6, and the method according to the invention terminated.

1-9. (canceled)

10. A method of logging in a terminal at an access point of a local communication network, the access point having a first radio transmitting and receiving unit operating at a first transmitting power for establishing communication between the terminal and the local communication network, the method comprising:
detecting the terminal by the access point; and
reducing the first transmitting power of the first radio transmitting and receiving unit such that the communication between the terminal and the local communication network is enabled exclusively within a near field of the access point, the near field having a smaller area than a standard enabling area defined by all locations enabling the communication between the terminal and the local communication network when the terminal is present at the locations and the first radio transmitting and receiving unit is operating at the first non-reduced transmitting power.

11. The method according to claim 10, wherein the terminal is a mobile terminal.

12. The method according to claim 10, further comprising:
sending a signal to the terminal after detecting the terminal by the access point and before reducing the first transmitting power of the first radio transmitting and receiving unit; and
initiating a reduction of a second transmission power of a second radio transmitting and receiving unit of the access point by the terminal after receiving the signal such that a communication between the terminal and the local communication network is enabled only within a near field of the terminal.

13. The method according to claim 12, wherein the signal includes a first message comprising a signal receiving level, the signal receiving level being higher than a signal receiving level actually measured by the access point.

14. The method according to claim 13, wherein the signal receiving level actually measured by the access point is a Received Signal Strength Indicator (RSSI) value

15. The method according to claim 10, wherein the signal includes a second message comprising an instruction for the user to move the terminal into the near field of the access point.

16. The method according to claim 15, wherein the second message is re-transmitted to the terminal if the terminal has not been moved into the near field of the access point within a specified time period after receiving the second message by the terminal.

17. The method according to claim 16, wherein the reduced first transmission power is increased at least temporarily to a level corresponding to the non-reduced transmission power.

18. The method according to claim 16, wherein the second message is repeatedly re-transmitted.

19. The method according to claim 12, wherein the first and second transmitting and receiving units operate according to a short-range radio standard.

20. The method according to claim 13, wherein the short-range radio standard comprises a Bluetooth specification.

21. An access point of a local communication network for logging in a terminal at the access point, comprising:
a first radio transmitting and receiving unit operating at a first transmitting power for establishing communication between the terminal and the local communication network, wherein the access point is configured to:
detect the terminal; and
reduce the first transmitting power of the first radio transmitting and receiving unit such that the communication between the terminal and the local communication network is enabled exclusively within a near field of the access point, the near field having a smaller area than a standard enabling area defined by all locations enabling the communication between the terminal and the local communication network when the terminal is present at the locations and the first radio transmitting and receiving unit is operating at the first non-reduced transmitting power.

22. A terminal configured to be logged in at an access point of a local communication network, the access point comprising a first and a second radio transmitting and receiving unit operating at a first respectively second transmitting power for establishing communication between the terminal and the local communication network, the terminal comprising a signaling device for transmitting a trigger signal to the second radio transmitting and receiving unit, the trigger signal initiating a reduction of the second transmission power, wherein the access point is configured to:
detect the terminal; and
reduce the first transmitting power of the first radio transmitting and receiving unit such that the communication between the terminal and the local communication network is enabled exclusively within a near field of the access point, the near field having a smaller area than a standard enabling area defined by all locations enabling the communication between the terminal and the local communication network when the terminal is present at the locations and the first radio transmitting and receiving unit is operating at the first non-reduced transmitting power.
